(19) United States
(12) Patent Application Publication
(10) Pub. No.: US 2004/0216357 A1
(43) Pub. Date: Nov. 4, 2004

(54) Fish-attractant product and methods of making and using it

(75) Inventor: Joseph A. Bobrowski, Broomall, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: XA Fishing, Inc.

(21) Appl. No.: 10/856,645

(22) Filed: May 28, 2004

Related U.S. Application Data
(63) Continuation-in-part of application No. 10/405,275, filed on Apr. 2, 2003.
(60) Provisional application No. 60/369,576, filed on Apr. 2, 2002.

(51) Int. Cl. A01K 85/00

(52) U.S. Cl. 43/42.06

(57) ABSTRACT

A fish-attractant product that facilitates catching fish includes a body preformed into a predetermined shape from a material dissolvable in water. The body of the product contains an olfactory and/or gustatory fish-attractant material that is releasable in water in which the product is immersed. The product is adapted in use not to be swallowed by a fish and is directly and/or indirectly attachable to a fishing line ahead of a lure or a baitable hook, such that the fish-attractant material during use provides a fish-attracting odor and/or taste through dissolution of the body. The product is a separate component designed to add fish-attractant gradually to the water by positioning it on the fishing line directly in front of the selected lure or the angler's preferred bait. Methods of making and using the product are also disclosed.

### CROSS-REFERENCE TO RELATED APPLICATIONS

This application is a continuation-in-part of copending U.S. patent application Ser. No. 10/405,275, filed Apr. 2, 2003, which claimed the benefit of the U.S. Provisional Application No. 60/369,576, filed Apr. 2, 2002. The disclosures of both of these applications are hereby incorporated herein by reference.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The present invention relates to a non-swallowable olfactory fish-attractant product for use in conjunction with a lure or a baited hook used in the sport of fishing. More particularly, the invention is directed to a dissolvable solid or semi-solid olfactory fish-attractant product preferably with a bore for threading the product onto a fishing line or to an attachment member that is attachable to a fishing line upstream of a conventional fishing lure or baited hook used in many types of fishing. As used herein, the term “fish-attractant product” refers to a product that contains at least one fish-attractant material that may include either or both of one or more substances to attract a fish to the area of the lure or baited hook or to stimulate a fish to bite the lure or the baited hook. The invention is usable in a variety of shapes, sizes, colors and configurations, such as beads, sinker shot, spring clips, and other embodiments of the invention, as set forth hereinafter.

There are many different fishing lures comprised of a wide variety of devices developed to attract fish. There has been substantial development in the field of fishing lures and an extensive spectrum of such lures are available for use by fishermen. Such lures typically are based on visual or auditory signals used to attract fish to the hook, and have been a long-time substitute for the use of live bait. Artificial baits and lures have a disadvantage of not having the scent or odor in the water which attracts fish to the area or to the hook. In response to this need, there has been developed a variety of olfactory and gustatory fish attractants to attract fish to the area where the fish will be caught. One method has been to pour or spread fish attractant on the water surface in the form of oils, pastes, liquids, aerosols or gels or to apply to a lure an oil, paste, liquid, aerosol or gel which contains an attractant of some type. Live bait is also used by fishermen which has a natural scent, though not always as strong or effective a scent as desirable. It is therefore desirable, in some instances, to accentuate or supplement the odors associated with live baits, as well. Attractants and stimulants accentuate the feeding urge in fish. Attractants and stimulants are Pavlovian in nature.

Chemoreception is the detection process by a fish that combines olfaction (smell) and gustation (taste). A fish's olfactory senses are used primarily to identify, locate and track prey. Gustatory senses are used primarily to determine whether something is edible or not. When odor molecules in the fish's receptor sites exceed a certain detection limit, the fish can distinguish other substrates in the water from food. Strong odors can even arouse dormant fish, and the right combination of odors can confirm to the fish that the target is food and that it should be consumed. Fish do not need to touch the offering to determine food. When the attractant or stimulant concentration exceeds the receptor limits, the offering is seen as food. Both olfactory and gustatory cells detect waterborne chemicals and bind those molecules to receptor sites that trigger electrical changes in receptor cells that cause nerve impulses to be sent to the brain. Much like putting a key into a lock, the receptor fit may be exceptional, good or poor. Good to excellent receptor fits stimulate the receptor cells strongly. Some receptor pockets accept a multitude of stimulants, while others, very few; but generally, the more stimulant molecules that bind, the stronger the nerve response that receptor type generates. Receptor cells determine whether a fish will respond. Since receptors can only respond to molecules that make physical contact when dispersed through water, the stimulation a fish can have is limited. Qualities of materials affecting a fish's smell and taste that are stimulating to a fish's receptor sites include those substances that are small enough to fit into the receptor pockets, water-soluble, and capable of binding with one or more receptor sites. Large molecules like proteins, oils and fats cannot fit into receptor pockets and go unnoticed by fish. Water-insoluble materials such as fats and oils are rarely dispersed as single molecules into the water, and hence go unnoticed by fish. In short, water-insoluble substances do not exist to fish. Jones, Keith A., Knowing Bass, 2002, The Lyons Press.

Attractants can be divided into three categories: applied scents, preformed scents, and scent impregnated plastics. Applied scents are best described as manufactured liquids, aerosols and pastes which are applied to lures in order to enhance smell and taste. Applied scents disperse quickly and lose effectiveness after several minutes, even in cold water where scent dispersion is naturally stalled by diminished molecular activity. Applied scents are messy and cumbersome to apply with and must be reapplied often. Lures must be cleaned properly after using applied scents or the lure may become unusable. Lures can be made more scent-friendly by attaching squares of sponge, yarn or Velcro® hook and loop fasteners where the porous/fibrous/composite additives hold more scent and may provide additional time-released dispersal, although such materials can also severely diminish lure performance as well as cover a lure's finish, minimizing its attractiveness. Some manufacturers add a blend of fish and shrimp oils and salt hoping that the bait will taste like something natural to a fish. The hoped for result is that the fish will hold onto the bait for a longer period of time before rejecting it as a fake. There are scents that spray onto a bait before each cast, as well as pastes that rub on or insert into cavities in the baits, even though such products typically contain shrimp or bait fish product (oil based) which cannot be smelled by fish due to their insensitivity to water insoluble materials. In contrast, the present invention requires no cleanup and does not require constant reapplication. The present invention is non-oil based, water soluble, biodegradable and non-toxic.

Preformed scents are moldable and are manufactured to be fished on a hook. They appear most typically as a dough, morsel or nugget and are formed around a hook. Preformed baits are usually designed to retain their effectiveness for longer periods than liquid attractants although they also suffer performance problems when their outside layer has depleted its attractants. Moldable scents cannot be used with lures. The present invention can be used with any lure or live bait.

Scent impregnated plastics are not as powerful smelling as liquid attractants or preformed bait but can be more visually stimulating to fish when molded as a rubber worm or grub. Each company uses its own formula of plastic material, typically plastisol, in the injection process to achieve the desired softness and lifelike texture. Coloration, shape and action attract fish while taste and smell cause them to bite. Lures and attractants work best where live bait may be illegal or cumbersome to use. Scent-impregnated plastics are not complementary to other lures. Due to heat and humidity, they do not age well in a tackle box, sometimes damaging or destroying other lures if left exposed. More so, scent-impregnated plastics can only disperse that scent after splashdown which can permeate the plastic in which it is encased. Much differently, the present invention allows fishermen to use attractants in combination with their favorite lure, requires no cleanup, will not damage other lures and can even be used with a scent-impregnated plastic for extra stimulation of a fish's senses.

Until the present invention, attractants either quickly dispersed or did not provide a large enough envelope of scent to be effective. Fast dissolving agents create a large but brief scent space while slower dissolving scents generate weaker spaces. The present invention provides a strong scent trail to overcome the “noise” (meaningless smells and tastes) a fish must traverse, as well as a longer lasting scent enabling them to hone in on their target.

Although most fishermen believe a liquid scent provides a “jet-trail” of scent, the truth is that most of the scent, whether liquid, aerosol, paste, preformed or plastic, is dispersed almost immediately upon splashdown while what remains is quickly washed off. Worse yet, as scent is used up, it creates negative polarity where the scent fades out. Negative polarity creates the unwanted effect of creating a trail whose scent leads away from the lure, not towards it. When a lure splashes down, the majority of the scent is spent; hence, a fish may follow a scent leading to where the lure was. As an example of their dissipating nature, the Bass Anglers Almanac recommends that lures be given an “additional shot” of applied attractant every ten casts, “to keep it fresh.”

Scent-impregnated plastics also lose a good deal of their scent upon splashdown and do not quickly disperse. Studies have shown that plastics produce small scent spaces and actually “lock in” scent until gestation (eating). The plastic lure locks in scent until the lure is bitten into, if at all. Plastics may only produce a scent space of approximately 12 inches (30.5 cm) at best according to recent studies.

There are also some scents which never disperse because they are either totally encased in plastic or other similar material or they are water insoluble, rendering them useless and odorless to fish. Typical examples include derivatives of highly purified oily foods such as herring, shad and crayfish composed of fatty compounds insoluble in water. Oil-based scents do not attract fish because fish cannot smell them. Studies show that oil-based products may have some benefit since they are able to mask offensive odors by encasing repellant smells in an oily barrier, thus preventing a fish from sensing offensive odors. Oils make great masking agents but are poor flavor carriers as they cover up both good and bad odors. Oil-based products cannot both mask and attract at the same time. Other scents claim the use of enzymes (but the molecules are too large to fit into the receptor sites of fishes), pheromones (that stimulate the fish's sex drive, not the feeding drive) and kairomones (distress signals given off by certain prey fish, although too costly to derive).

The key to effective scents is both quicker and extended dispersion. The present invention does not dissipate upon splashdown, but disperses scent and/or taste at a constant rate until the product is completely dissolved.

In the past, various inventors have attempted to address the problem of adding a fish attractant to an existing lure used by a fisherman. Many fishermen have a series of lures which they prefer to use, for a variety of different reasons. Using some of the scented lures that may be available on the market prevents the fishermen from utilizing lures they prefer, because they must settle for using conventional methods to add scent or odor to the existing lure. Inventions which were the subject of prior issued patents have attempted to address this concern in a variety of different fashions. Some are described below.

U.S. Pat. No. 6,161,325, issued to Hugunin, discloses an absorbent scent tab that is fashioned to a bucktail-type fishing lure during manufacturing. The scent tab comprises an absorbent body in the shape of a disk or other form. However, among other things, Hugunin does not teach threading the body of the device or otherwise applying the device to a fishing line upstream of an existing lure; nor does it teach the use of a dissolvable preformed body manufactured to already include fish-attractant material, as distinguished from an absorbent body to which a liquid scent is applied after the body is manufactured.

U.S. Pat. No. 6,079,146 issued to Larsen discloses a scent strip for a conventional fishing lure which is comprised of a waterproof adhesive-backed tape which is impregnated with a scent attractant. This device is limited in that the tape must be attached to an existing lure which may alter the fluid dynamics of the lure or otherwise be affected by the limitations of the adhesive qualities of the tape and the surface material qualities of the lure. Some lures are simply not adaptable to attachment of an adhesive tape style device. Tape also alters a lure's color and reflections, diminishing performance.

U.S. Pat. No. 5,113,606 issued to Rinker discloses a Mepps®-type fishing lure with a body to which is applied a liquid or paste scent material. The body is threaded onto the shaft and becomes a permanent part of the lure which is attached to a fishing line. This patent teaches use of a separate device which is attachable to an existing lure between the lure and a fishing line. Among other things, it does not teach the use of an attachable dissolvable product such as the present invention.

U.S. Pat. No. 3,953,934 issued to Visser for an odoriferous fishing device is directed to an artificial fishing lure in the form of a plastic worm or spinner with a scent attractant device threaded onto a fishing line which is upstream of the artificial lure or the baited hook. Among other differences, the scented device disclosed is made of a porous metallic body impregnated with a scent. The porous metallic body is reusable and is not dissolvable, unlike the present invention.

The present invention is a dissolvable fish-attractant product which is attachable upstream of a fishing lure or baited hook by direct or indirect attachment to a fishing line. It is intended for use in addition to, rather than in place of, a lure or baited hook. In use, the product is comprised of a body preformed into a predetermined shape from a dissolvable material that comprises at least an olfactory fish-attractant material, and preferably also a gustatory fish-attractant material. The product is not adapted to be swallowed by a fish so as to catch or hook a fish by itself. The fish-attractant material provides a fish-attracting scent, taste or both, through complete dissolution of the product. Thus, when the product has dissolved off the line, it provides a clear indication that another such product must be used, rather than leaving to guessing or intuition that it is time to re-apply a liquid, paste or other type of attractant material to a non-dissolving body as in the prior art. With such prior art devices, there is a tendency to use too much liquid or apply it too frequently, thus resulting in an uncontrolled amount and wasted attractant material. The present invention may be formed in a variety of shapes, sizes, colors and configurations to overcome the disadvantages of a liquid-applied scent. The fish-attracting material is released in a controlled manner over time, which overcomes the disadvantages of sprayed-on liquid scent which may disperse quickly in the water. By using the present invention, a scented and/or gustatory attractant attached to a conventional fishing line, a fisherman may also use any desired lure or bait in a long-lasting attractant environment without altering the existing fishing lure or bait.

The present invention allows a fisherman to catch more fish by enhancing a fisherman's favorite lure or live bait with an irresistible scent and/or taste. There is no mess, no ooze, no aerosol spray, no spills, no lure cleanup, and no dirty, smelly tackle boxes. The product provides a space-saving, flavorful and fresh scent, each and every time.

Among the benefits and advantages of the present invention, including those mentioned above, are for example, without limitation:

The present invention is a solid, holed product, preferably threaded on but also indirectly attachable to the fishing line ahead of the baited hook or a lure. The product disperses supercharged feeding attractants and/or stimulants over the lure, typically 30-40 minutes or longer depending on conditions. It fully dissolves, letting the fisherman know when it is time to be replaced.

The lure does not retain residue when the product is removed or dissolves. The product requires no lure cleanup and can be changed as often as needed. The product is affixed indirectly, or preferably directly to the line, rather than to a lure or a baited hook, ultimately acting as a complement to lures or baited hooks, rather than replacing them.

The product is biodegradable, non-toxic to fish and humans and is safe for fisherman of all ages.

The product provides a supercharged scent trail and in some embodiments, a taste trail to overcome the “noise” (meaningless smells and tastes) a fish must traverse, as well as a longer lasting attractant enabling them to hone in on their target.

The present invention is not adversely affected by the different pH of fresh water or salt water. In fresh water, it is effective for bass, trout, catfish, walleye, crappie, bluegill, carp, and many more. In salt water, it is effective for stripers, bluefish, weakfish, fluke, flounder and many more. In ice fishing, the present invention can be used with any setup.

As used herein, the article “a” or a singular component or ingredient includes the plural or more than one component or ingredient, unless specifically and explicitly restricted to the singular or a single component or ingredient. Moreover, certain terminology is used in the following description for convenience only and is not limiting. The words “left” and “right” designate directions in the drawings to which reference is made, but are not limiting with respect to the orientation in which the fish-attractant product of the present invention is used or in the manufacture of the product. The “front” of the fish-attractant product refers herein to the portion of the product toward the reel and away from the hook, while “rear” of the fish-attractant product refers herein to the portion of the product toward the hook and away from the reel. Moreover, as used herein, the symbol “%” or the word “percent” means weight percent of an ingredient in the composition as a whole of which the ingredient is a component, unless another meaning is clear from the context.

### BRIEF SUMMARY OF THE INVENTION

One aspect of the present invention is a fish-attractant product comprising a body preformed into a predetermined shape from a material dissolvable in water comprising at least one of an olfactory fish-attractant material and a gustatory fish-attractant material that is releasable in water in which the product is immersed, the body being made of a composition comprising the fish-attractant material in an amount to be releasable in water for a period of time of about 15 minutes to about 60 minutes and a cellulose derivative polymer in an amount such that the body is dissolvable in water over a period of time of about 15 minutes to about 60 minutes, the product being adapted in use not to be swallowed by a fish and being attachable at least one of directly and indirectly to a fishing line ahead of at least one of a lure and a baitable hook, such that the fish-attractant material during use provides at least one of a fish-attracting odor and a taste through dissolution of the body that facilitates catching fish.

Another aspect of the present invention is a method of fishing comprising attaching at least one of directly and indirectly to a fishing line ahead of at least one of a lure and a baitable hook, a fish-attractant product comprising a body preformed into a predetermined shape from a material dissolvable in water comprising at least one of an olfactory fish-attractant material and a gustatory fish-attractant material that is releasable in water in which the product is immersed, the body being made of a composition comprising the fish-attractant material in an amount to be releasable in water for a period of time of about 15 minutes to about 60 minutes and a cellulose derivative polymer in an amount such that the body is dissolvable in water over a period of time of about 15 minutes to about 60 minutes, the product being adapted in use not to be swallowed by a fish and being attachable at least one of directly and indirectly to a fishing line ahead of at least one of the lure and the hook, such that the fish-attractant material during use provides at least one of a fish-attracting odor and a taste through dissolution of the body that facilitates catching fish.

Another aspect of the present invention is a method of making a fish-attractant product comprising:

(a) mixing until thoroughly blended, to form a product mixture, ingredients comprising

(i) fish-attractant material in an amount to be releasable in water for a period of time of about 15 minutes to about 60 minutes,

(ii) a cellulose derivative polymer in an amount such that the body is dissolvable in water over a period of time of about 15 minutes to about 60 minutes, and optionally

(iii) at least one excipient,

(iv) at least one tableting aid, and

(v) at least one colorant; and

(b) forming the product mixture into a fish-attractant product having a dissolution time in water of about 15 minutes to about 60 minutes and a peak crush strength of about 25 kiloponds (kp) to about 40 kp.

Yet another aspect of the present invention is a method of making a fish-attractant product comprising:

(a) mixing until thoroughly blended, to form a product mixture, ingredients comprising

(i) fish-attractant material in an amount to be releasable in water for a period of time of about 15 minutes to about 60 minutes,

(ii) a hardenable release material such that the body is dissolvable in water over a period of time of about 15 minutes to about 60 minutes, and optionally

(iii) at least one colorant; and

(b) forming the fish-attractant product by treating the product mixture so that it will harden at about room temperature in a mold into a fish-attractant product having a dissolution time in water of about 15 minutes to about 60 minutes and a peak crush strength of about 25 kp to about 40 kp.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is an isometric view of one exemplary embodiment of the invention in the form of a spherical bead on a fishing line;

FIG. 2 is an isometric view of the spherical bead form of the invention of FIG. 1 shown in use on a fishing line directly upstream or ahead of a typical exemplary fishing lure including a treble hook;

FIG. 3 is an isometric view of another exemplary embodiment of the invention in the form of a cylinder on a fishing line;

FIG. 4 is an isometric view of another exemplary embodiment of the invention having a bullet-like shape on a fishing line;

FIG. 5 is an isometric view of another exemplary embodiment of the invention in the form of an elongated ovoid on a fishing line;

FIG. 6 is an isometric view of another exemplary embodiment of the invention in the form of an elongated ovoid on a fishing line;

FIG. 7 is an isometric view of another exemplary embodiment of the invention in the form of a cone on a fishing line;

FIG. 8 is an isometric view of another exemplary embodiment of the invention in the form of a spherical bead with an integrally formed attachment line which, in turn, is adapted for attachment to a fishing line;

FIG. 9 is an isometric view of the embodiment of the invention of FIG. 8 shown in use attached on a fishing line directly upstream or ahead of a typical exemplary fishing lure including a treble hook.

FIG. 10 is an isometric view of a first embodiment of a line lock device for securely holding a fish-attractant product so that the product can be easily mounted on or removed from a position on a fishing line ahead of a lure or a baited hook.

FIG. 11 is an isometric view of the embodiment of the line lock device shown in FIG. 10 in which a fish-attractant product has been mounted on the device.

FIG. 12 is a schematic representation of a second embodiment of a line lock device showing an exemplary fish-attractant product attached thereto and installed on a fishing line ahead of a lure or a baited hook.

### DETAILED DESCRIPTION OF THE INVENTION

The present invention includes a fish-attractant product to assist in fishing, a method of fishing using the product, and a method of manufacturing the product that takes advantage of the unique qualities of the fish-attractant invention disclosed herein. The invention may be fashioned in a variety of preferred embodiments, shown in the various drawings but comprised of essentially the same material which is used to release an olfactory fish-attractant, and preferably also a gustatory fish-attractant, over a period of time.

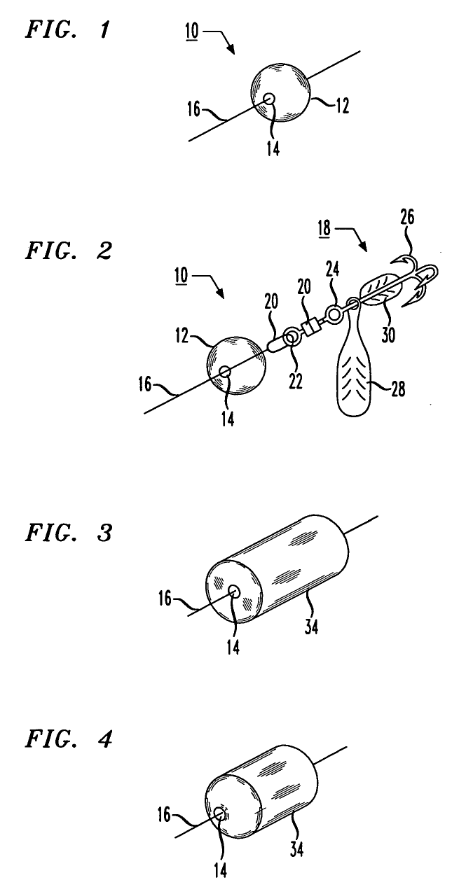

Referring now to the drawings, wherein like numbers refer to like parts throughout the several views, FIG. 1 illustrates one exemplary embodiment of the fish-attractant product 10 having a body in the form of a spherical bead 12 having a bore 14 through which a fishing line 16 extends. In all of the figures, in which the fish-attractant product 10 is shown in use on a fishing line 16, the rod and reel (not shown) with which the fishing line and invention are used, would be off the left-hand side of the drawing sheet, and the lure or hook with which the fish-attractant product 10 is used would be located on the right-hand side of the fish-attractant product 10. Thus, the front of the fish-attractant product is toward the left-hand side of the drawing sheets and the rear of the fish-attractant product is toward the right-hand side of the drawing sheets.

The fish-attractant product 10 is adapted for use as an accessory preferably to be slid onto a fishing line 16, and preferably to be directly upstream or ahead of an artificial fishing lure 18, such as shown in FIG. 2. Thus, FIG. 2 illustrates the fish-attractant product 10 having a body in the exemplary form of the spherical bead 12 shown in FIG. 1 in which the fishing line 16 is threaded through the bore 14 of the spherical bead 12. The fishing line 16 is shown connected at 17 by a loop, or fisherman's knot, such as a clinch knot or other suitable fisherman's knot, to a barrel (swivel) connector 20 having an eyelet 22 to which the fishing line is attached. While the use of a barrel connector is preferred, it is not essential. The barrel connector 20 also includes an eyelet 24 which may be integrally or unitarily formed with a shaft of a treble hook 26. The lure 18 also is shown as including a spinner 28, typically made of a shiny metal and a bead 30 of any suitable material well known to fisherman. Instead of a spinner 28 and bead 30, the treble hook may extend from an artificial worm, minnow or other artificial bait or live bait of any desired type. Additionally, although a treble hook 26 is illustrated in FIG. 2, the fish-attractant product 10 of the present invention can be used with any type of hook.

An advantage of the present invention is that the fish-attractant product 10 is adapted to simply fit on a fishing line upstream or ahead of a lure or hook or a leader containing a lure or hook, although alternative embodiments in which the fish-attractant product is attached indirectly to a fishing line ahead of the lure or baited hook are shown in FIGS. 8-12. The fish-attractant product 10 is not adapted or intended to be swallowed or struck, unlike many components of an artificial lure or bait used with a hook, which are intended to be swallowed by a fish. The benefit of having the fish-attractant product 10 adapted to simply fit on a fishing line upstream or ahead of a lure, hook or leader is that when the fish-attractant material is spent through complete dissolution of the body of the fish-attractant product, it is a simple matter merely to replace the spent product with a new product without having to discard an entire lure or hook. An advantage of the dissolvable nature of the fish-attractant product 10 is that it is readily apparent how much of the product is left at any given time, compared to a new product. The fish-attractant material forming the active ingredient or ingredients is discharged over a period of time based on the water soluble qualities of the fish-attractant product, as described more fully below.

The fish-attractant product has a body that can be configured in any number of physical configurations, depending on the preference of the user. FIGS. 2-7 show various other exemplary configurations for the fish-attractant product 10, in addition to the spherical bead 12 shown in FIGS. 1 and 2. In each of these embodiments, the product includes a bore 14 through which a fishing line 16 is threaded, one end typically being attached to a fishing reel and the opposite end, closer to the product 10, being attached to a lure, leader or hook, preferably immediately downstream or behind the product 10.

FIG. 3 shows the product 10 with a body in the form of a cylinder 32. FIG. 4 shows the product 10 with a body in the form of a cylinder having a hydrodynamic front to create a bullet-like body shape 34 that provides a hydrodynamic shape as the product travels through the water. Although the front is illustrated as rounded, it could have a greater angle of taper, if desired. Also, the bullet-shaped body 34 could be tapered toward the rear, if desired, but in a preferred embodiment, the rear of the bullet-shaped body 34 may have a slightly concave shape in an area surrounding the bore 14 and the rear may further have a slightly convex shape from the outer cylindrical periphery until it merges with the concave shape around the bore, as best seen in FIG. 11.

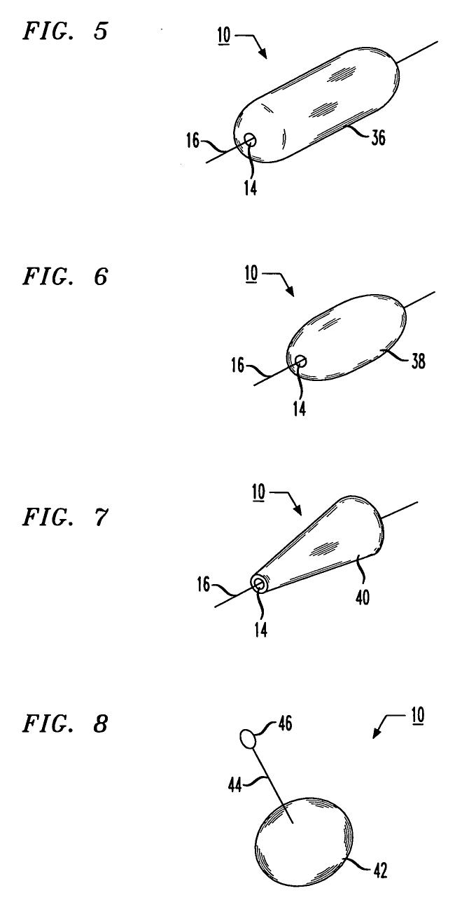

FIG. 5 shows the product 10 with a body in the form of an ovoid 36, and preferably in the form of an elongated ovoid. FIG. 6 shows the product 10 with a body in the form of an ellipsoid 38, and preferably in the form of an elongated ellipsoid.

FIG. 7 shows the product 10 with a body configured as a cone 40. With an asymmetrical shape such as that shown for the cone 40, it is desirable to have the front be the narrow end of the cone 40 pointed in the direction of travel of the fish-attractant product as it, along with the artificial lure and hook, are reeled in during the normal course of fishing.

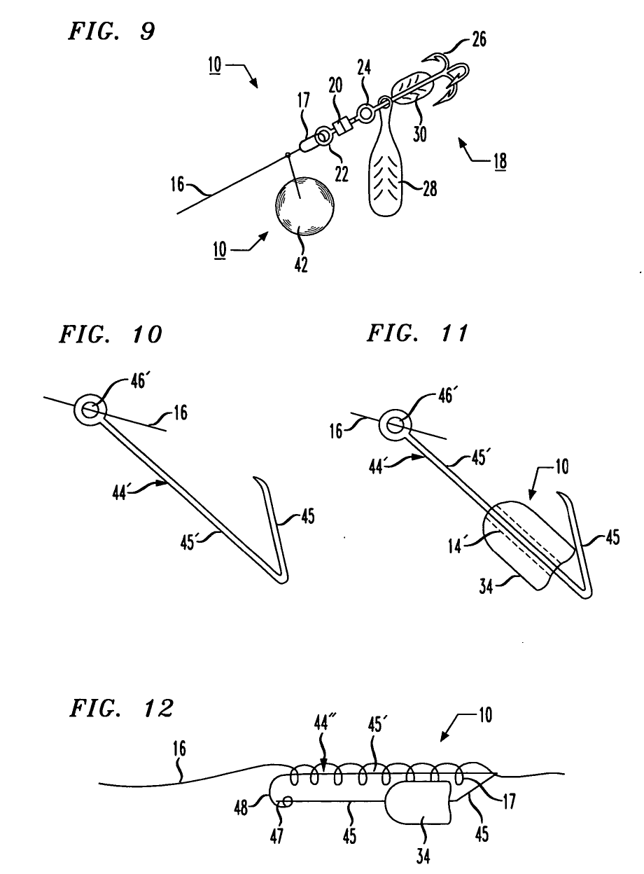

An alternate embodiment of a fish-attractant product 10 of the present invention is shown in FIGS. 8 and 9. In this embodiment, the fish-attractant product has a body with any suitable shape, such as spherical bead 42, for example. However, unlike the prior embodiments, the fish-attractant product 10 shown in FIGS. 8 and 9 includes a first embodiment of an attachment member 44 that in FIGS. 8 and 9 is integrally formed with the body. The attachment member 44 may be of any suitable type, such as an attachment line, having an eyelet, loop or fisherman's knot 46 formed at its free end and adapted for attachment to the fishing line 16 as best shown in FIG. 9. The other components of a fishing system as shown in FIG. 9 may be the same as described previously with respect to FIG. 2. As with the first embodiments, the fish-attractant product 10 shown in FIGS. 8 and 9 is adapted to be attached to the fishing line 16 upstream or ahead of the lure 18 including the hook 26. The attachment member 44 is embedded within the body of the fish-attractant product during its manufacture, as explained more fully below.

FIGS. 10-12 show other alternate embodiments of an attachment member in the form of a line lock device 44′ (FIGS. 10 and 11) and 44″ (FIG. 12) for attaching a fish-attractant product 10, such as one having a body in the form of a bullet shape 34, to a fishing line 16 ahead of a lure or baited hook, not shown. FIG. 10 shows a first alternative embodiment of an attachment member 44′ that may be made of a resilient material, such as nylon or other synthetic polymeric material or stainless spring steel, for example, among various other materials. The attachment member 44′ includes an eyelet 46′ through which the fishing line 16 may be threaded. The attachment member 44′ also includes a retention member 45 preferably integrally and unitarily formed with a shaft portion 45′ which in turn is preferably integrally and unitarily formed with the eyelet 46′.

FIG. 11 shows the fish-attractant product having a bullet-shaped body 34 retained by the line lock device 44′. To apply the fish-attractant product 10 to the line lock device 44′, a user simply pushes the line lock device at the vertex of the retention member 45 and shaft 45′ through the bore 14 of the product 10, starting at its front end. The retention member 45 will then be bent against the shaft 45′ until the free end of the retention member 45 passes through the bore 14. At that point, the retention member 45 will spring open and retain the product 10 on the shaft 45′ as best shown in FIG. 11. The line lock device or attachment member 44′ has an advantage over an attachment member 44 as shown in FIGS. 8 and 9, in that once the line lock device 44′ is attached to a line, a new fish-attractant product 10 can be inserted onto it without untying or otherwise removing either the attachment member 44 from the fishing line 16 or without removing the fishing line 16 from the lure or hook. Additionally, if desired, such as to put a different type of fish-attractant product 10 on the line lock device 44′, the old fish-attractant product 10 may be removed before it is completely used simply by reversing the installation process. If desired, instead of connecting the line lock device 44′ to the line 16 by threading the line through the eyelet 46′, a barrel connector (not shown) or other suitable intermediate attachment device could be used to attach the line lock device to the fishing line 16.

FIG. 12 shows another embodiment of a line lock device or attachment member 44″. Rather than having an eyelet 46′ through which the fishing line 16 is threaded, the line lock device 44″ is similar to a safety pin. It includes a curled front end preferably integrally and unitarily formed with a shaft 45′ which, in turn, is preferably integrally and unitarily formed with a retention member 45 as described above with respect to FIGS. 10 and 11. In the line lock device 44″ of FIG. 12, it is not necessary to thread the fishing line through an islet 46′, but instead, the line 16 simply may be wrapped around the device as indicated by turns 17 around the shaft 45′ of the line lock device 44″, along the side of the fish-attractant product 10, and out through a space between the retention member 45 and the rear and side of the fish-attractant product 10. The curled front end may form a clasp 48 with a hole to retain the end 47 of the retention member 45 after the fish-attractant product 10, for example having a bullet-shaped body 34, is placed on the end 47 of the retention member 45 before the end is retained by the clasp 48. If desired, the clasp may be an additional component such as that found on a standard safety pin, so long at it reasonably reliably retains the fish-attractant product 10 on the line lock device 44″. This line lock device embodiment has all of the advantages of the line lock device embodiment 44′, with an additional advantage that the fishing line can simply be looped around the line lock device 44″ without having to remove the line 16 from the lure or hook or otherwise tie or attach the line lock device 44′ to the fishing line 16.

The fish-attractant product 10 may be attachable directly or indirectly to the fishing line 16 ahead of the lure or a hook in other ways and using other devices than as shown in FIGS. 8-12. For example, the body of the product 10 could be in the form of interlocking components which surround the line and can be slid into place in a locking manner to be retained on the line until the product dissolves. Alternatively, the product 10 could be formed with zig-zag slots through which a fishing line 16 can be treaded, where the slots are arranged in such a manner that the product is not likely to be able to fall off of the line, even while fishing in weedy areas. Other attachment methods will be apparent to those skilled in the art in view of the present disclosure.

The fish-attractant product 10 of the present invention is made by forming a composition described hereinafter into any desired shape, such as, for example without limitation, any of the shapes described above. The product may be of any desired size, but the size should be such that the product has an appropriate dissolution time so that the active ingredient or ingredients forming the fish-attractant material will be released, preferably at a uniform rate, over the period of time set forth below. In general, a suitable fish-attractant product can be made having a weight of about 1 to about 5 grams, with a preferred weight of about 2 grams.

The fish-attractant product of the present invention is made of a compressed or molded composition comprising the fish-attractant material in an amount to be releasable in water for a period of time of about 15 minutes to about 60 minutes, and a cellulose derivative polymer in an amount such that the body is dissolvable in water over a period of time of about 15 minutes to about 60 minutes. Optional ingredients include at least one excipient, at least one tableting aid, and at least one colorant. All of the ingredients are biodegradable, non-toxic and safe for fish and humans.

The active ingredient or ingredients forming the fish-attractant material of the fish-attractant product 10 may, in the broadest sense of the present invention, be any suitable olfactory or gustatory, and preferably, both, attractant material, or stimulant material or attractant and stimulant material known in the art or to be developed in the future. As mentioned above, water-soluble materials are strongly preferred, since oil-based materials, while useful for masking scents, are not effective attractants. Thus, for example, fish-attractant materials of the prior art include many diverse ingredients. Blood, limburger cheese or asafoetida are disclosed in U.S. Pat. No. 2,703,945, the disclosure of which is hereby incorporated herein by reference. Anise oil, menhaden oil, rhodinol or bacon fat are disclosed in U.S. Pat. No. 3,953,934, the disclosure of which is hereby incorporated herein by reference. U.S. Pat. No. 4,530,179, the disclosure of which is hereby incorporated herein by reference, discloses salt (sodium chloride) as a fish attractant. U.S. Pat. No. 4,993,183, the disclosure of which is hereby incorporated herein by reference, discloses banana oil as a fish attractant. U.S. Pat. No. 5,089,277, the disclosure of which is hereby incorporated herein by reference, discloses a number of fish attractants, including various amino acid mixtures such as glycine, alanine, aspartic acid and glutamic acid; amine compounds such as tryptamine, tyramine and betaine; powdered bone meal; powdered food solids; rhodinyl acetate; dried slaughterhouse waste products; powdered fish, egg and dried milk products; molasses; and synthetic spices having a scent similar to that of fish meal, fish oil, stale fish or shell fish, for example. U.S. Pat. No. 6,079,146, the disclosure of which is hereby incorporated herein by reference, discloses attractants including fish meal, fish flavoring and fish oil.

The preferred fish-attractant material for use in the present invention, which has been shown to be or is believed to be very effective, comprises at least one amino acid, and preferably two or more amino acids. The preferred amino acid(s) may be selected from alanine and arginine, and more preferably, L-alanine and L-arginine, although aspartic acid and glutamic acid are also preferred, all of which are olfactory fish-attractant materials. Other olfactory attractant materials include, for example without limitation, cysteine, histidine, methionine, serine, phenylalanine, betaine, glycine, inosine, taurine, lysine, purine, pterin, bile acid, glutamate, glutamine, leucine and taurine. Mixtures of any of these may also be used.

It is also preferred to include at least one gustatory attractant material affecting a fish's taste. One preferred material is the amino acid proline, and more specifically, L-proline. Other gustatory attractant materials include, for example without limitation cysteine, histidine, methionine, serine, phenylalanine, betaine, glycine, inosine, alanine, alanine, taurine, lysine, purine, pterin, bile acid, glutamate, glutamine, leucine, taurine and praline. Mixtures of any of these may also be used.

As will be noticed, many of the gustatory attractant materials are also olfactory attractant materials, and vice versa, although other singularly olfactory or gustatory materials may be used, as well. Other preferred fish-attractant material additives may include, for example without limitation garlic, anise, blood and earthworm. It is preferred to use both an olfactory attractant material and a gustatory attractant material. A presently more preferred combination is L-alanine and L-arginine as olfactory materials in combination with L-proline as a gustatory material.

The fish-attractant material should be present in the composition used to make the fish-attractant product 10 of the present invention in an amount suitable to attract fish and be releasable from the product over a period of time of about 15 to about 60 minutes, preferably about 30 to about 45 minutes, and more preferably about 40 minutes. To the extent that release of the fish-attractant material from the composition used to make the fish-attractant product is also a function of the dissolution rate of the product itself, the dissolution times should correspond to the foregoing release times. The dissolution times are controlled generally by the amount and type of the cellulosic derivative present and the hardness, more accurately termed the peak crush strength, of the fish-attractant product as discussed more specifically below, and the compression force used where the product is made using a compression device. The fish-attractant material should be present in the fish-attractant product in an amount of about 1% to about 75%, a preferred amount of about 10% to about 30%, and a more preferred amount of about 25%. In general, a smaller amount of fish-attractant material will result in a shorter strength, intensity or reach of effectiveness.

Another important ingredient of the composition used to make the fish-attractant product of the present invention is an appropriate release material that controls the release of the fish-attractant material from the composition. The preferred release material is a cellulose derivative polymer such as various cellulose ethers, which are readily available commercially (for example from Dow Chemical Co., Midland, Mich., USA) and are well known. They are generally prepared from alkali cellulose reacted with etherification agents, such as alkyl halides, halocarboxylic acids, dialkyl sulfates and alkylene oxides. The cellulose ethers include, for example, methylcellulose (MC), hydroxyethyl cellulose (HEC), hydroxypropyl methylcellulose (HPMC, now often referred to as hypromellose), hydroxypropyl cellulose (HPC), methylhydroxy propylcellulose (MHPC), ethyl hydroxyethyl cellulose (EHEC), methylhydroxy butylcellulose (MHBC), carboxymethyl cellulose (CMC), carboxymethyl methylcellulose (CMMC), hydroxyethyl hydroxypropyl methyl cellulose (HEHPMC), methyl hydroxyethyl cellulose (MHEC), and the like. Of these HPMC, MC, HEC, and CMC are preferred. Generally, the molecular weight of the cellulose ether is determined by the molecular weight of the cellulose pulp employed in its preparation. In this invention, the cellulose ethers have a molecular weight between about 10,000 to 500,000, preferably between 250,000 to 300,000. More preferred cellulose derivative polymers are HPMC, such as Dow Chemical Co.'s Methocel® HPMC cellulose ethers, especially those of the Methocel® E, Methocel® (F and Methocel® K products. A particularly preferred cellulose derivative polymer is Methocel® HPMC cellulose ether sold as Methocel® K Premium LV, having a pH of about 5.5 to about 8.0, a methoxyl content of about 19% to about 24%, an apparent viscosity in a 2% aqueous solution at 20° C. of about 78 milliPascal-seconds (mPa.s) to about 117 mPa.s when measured by the well-known rotation method and about 80 centiPoise (cP) to about 120 cP when measured by the well-known Ubbelhode method.

The cellulose derivative polymer is present in an amount such that the body of the fish-attractant product is dissolvable over a period of time of about 15 minutes to about 60 minutes, preferably about 30 minutes to about 45 minutes, and more preferably about 40 minutes. This dissolution characteristic can be achieved when the cellulose derivative polymer is present in an amount of about 1% to about 40%, preferably about 10% to about 30% and, more preferably about 15%.

The fish-attractant product may also be molded from a heated mixture which can be cooled to form a solid product, from a liquid mixture from which a liquid vehicle evaporates to form a solid product or from a liquid product that may be cured to form a solid product, such as is done to make hard candy, cough drops or lozenges. In these methods, the release material preferably is a sugar-based material, for example, that can harden with the appropriate peak crush strength to provide the desired release and dissolution times discussed above. Suitable sugar-based materials are listed below and are often used as excipients in tablets or other compressed products. Among many acceptable materials that can be used to form the basis for a suitable body in a mold without compression are materials based on raw, partially refined or fully refined sugar, sucrose, glucose, dextrose, fructose (also known as levulose), one or more other monosaccarides, sorbitol, mannitol, xylitol, one or more other disaccharides, one or more other oligosaccharides, one or more polysaccharides, such as starch, glycogen and chitin; and mixtures of one or more of the foregoing, among others not listed that would be familiar to those skilled in the art in view of the present disclosure.

The bulk of the body of the fish-attractant product 10 may optionally comprise, and typically does comprise, an excipient or inert material capable of forming a shaped body upon being compressed or molded so as to have the fish-attractant material releasability and product dissolvability characteristics mentioned above. Suitable excipient materials include, by way of example and not limitation, precipitated calcium carbonate, monobasic calcium phosphate, dibasic calcium phosphate, calcium hydrogen phosphate dihydrate, calcium hydrogen phosphate dehydrate, tribasic calcium phosphate, calcium sulfate, magnesium sulfate, microcrystalline cellulose, powdered cellulose, dextrose, kaolin, lactose, sorbitol, magnesium carbonate, magnesium sulfate, mannitol, sodium chloride, starch, pregelantinized starch, sucrose, compressible sugar and confectioner's sugar, as well as mixtures thereof. Preferred excipients are lactose and calcium hydrogen phosphate dihydrate (CaHPO₄.2H₂O). The excipient is present in an amount that is the balance of the weight of the fish-attractant product after the active ingredient(s) fish-attractant material, the cellulose derivative polymer, any tableting aids and, optionally, one or more colorants.

Especially where the fish-attractant product is a compressed or pressure molded product, it also preferably includes at least one tableting aid so as to enhance the formation of the body in a suitable mold or tableting press of any type that would be well known to those skilled in making tablets, such as pharmaceutical tablets, in view of the present disclosure. Types of tableting aids, include, for example, tablet anti-adherents, glidants, lubricants, flow aids, and other functional products that aid in forming or releasing tablets from equipment used to make them. Suitable tableting aids include, by way of example and not limitation, calcium stearate, magnesium stearate, stearic acid, zinc stearate, sodium stearyl fumarate, ascorbyl palmitate, micronized or non micronized talc, silica in various forms such as fumed silica, colloidal silica and precipitated silica and silica gel, sodium aluminum silicate, mineral calcium with stearic acid, glyceryl monostearate, glyceryl triacetate, hydroxypropyl methylcellulose pthalate (HPMCP), maltodextrin, octadecnonic acid, polyethylene glycol, shellac and especially purified shellac, soapstone, sodium benzoate, sodium lauryl sulfate, titanium dioxide, boric acid, sodium chloride, mineral oil and hydrogenated vegetable oil, and mixtures of any two or more thereof. The presently preferred tableting aid is magnesium stearate, alone or in combination with fumed silica, such as Cab-O-Sil® M5 fumed silica, available from Cabot Corporation, Boston, Mass., U.S.A. The tableting aid is present in any amount suitable to aid in the formation of the tablet and release of the tablet from the mold or tableting press. Thus, the tableting aid may be present in an amount of about 0.25% to about 5%, preferably about 0.5% to about 2%, and more preferably about 1%, depending on the type and combination, if any, of tableting aids.

If desired, the fish-attractant product of the present invention optionally may be colored using one or more of readily available and well-known coloring agents that may be chosen based on their demonstrated or presumed effect on the species of fish sought to be caught. One suitable example of a colorant of many that are too numerous to mention is red dye #40. Another is FD&C Aluminum Lake #40. These are preferred, since they provide a blood-red trail in the water as they are released when the fish-attractant product containing them dissolves in use, which provides a visual attractant effect. The amount of colorant can be adjusted to achieve the desired color intensity. Suitable products have been made using 2% red dye #40 or 2% FD&C Aluminum Lake #40, for example.

The present invention also includes a first method of making a fish-attractant product comprising:

(a) mixing until thoroughly blended, to form a product mixture, ingredients comprising

(i) fish-attractant material in an amount to be releasable in water for a period of time of about 15 minutes to about 60 minutes,

(ii) a cellulose derivative polymer in an amount such that the body is dissolvable in water over a period of time of about 15 minutes to about 60 minutes, and optionally

(iii) at least one excipient,

(iv) at least one tableting aid, and

(v) at least one colorant; and

(b) forming the product mixture into a fish-attractant product having a dissolution time in water of about 15 minutes to about 60 minutes and a peak crush strength of about 25 kp to about 40 kp.

In yet another embodiment, the invention is a second method of making a fish-attractant product comprising:

(a) mixing until thoroughly blended, to form a product mixture, ingredients comprising

(i) fish-attractant material in an amount to be releasable in water for a period of time of about 15 minutes to about 60 minutes,

(ii) a hardenable release material such that the body is dissolvable in water over a period of time of about 15 minutes to about 60 minutes, and optionally

(iii) at least one colorant; and

(b) forming the fish-attractant product by treating the product mixture so that it will harden at about room temperature in a mold into a fish-attractant product having a dissolution time in water of about 15 minutes to about 60 minutes and a peak crush strength of about 25 kp to about 40 kp. With this second method, other optional ingredients include, without limitation, excipients and mold release agents (which may be the same as the tableting aid, for example).

In the foregoing methods of making the product, the order of addition of ingredients is immaterial. The mixing may be done in any suitable mixer at any suitable rate for any suitable time to blend the ingredients to form a well-blended, uniform product mixture. It is preferred to mix the ingredients in a relatively low-humidity environment, preferably below about 45% relative humidity, more preferably below about 40%, and even more preferably below about 30%.

Once the product mixture is formed, the mixture is placed in any suitable mold or tableting press which would be well known to those skilled in the art in view of this disclosure. Preferably, the mold or press includes a rod of sufficient length and diameter to form the bore 14 through the fish-attractant product. A bore of any size suitable to allow the product to be attached to a fishing line through the bore or alternatively through the bore to an attachment member, such as line lock devices 44′ or 44″ as shown and described with respect to FIGS. 8-12. A cylindrical rod having a diameter of about 0.08 inch (2 mm) has been incorporated in a press and used successfully to form the bore 14 in a bullet-shaped body 34 of a fish-attractant product 10, though this dimension and shape are only exemplary and without limitation to other dimensions and shapes.

An alternative manner of forming a bore 14 in a body of the fish-attractant product 10 would be to drill a hole in the body after the product is formed into a desired shape. This could be done by placing the product in a suitable fixture and forming the bore by drilling a hole through the product. This is a less desirable method than forming the bore when the product is formed initially, not only due to the extra steps and labor necessary for doing so, but also due to waste of the material removed from the product to form the bore. For example, if a bore having a diameter of about 1/16 in. (1.6 mm) is made in a preformed body of 2 grams, it results in a reduction of about 0.2 gram in the weight of the product to about 1.8 grams. Thus, while this technique is possible, it is less preferable than method described above.

If it is desired to make a fish-attractant product of the type illustrated and described above with respect to FIGS. 8 and 9, a short line or other attachment member 44 can be placed in the mold or press before the product mixture is added to the mold or press. It is more practical to make the fish-attractant product 10 containing a line or other attachment member 44 using a non-pressurized mold where the product hardens, either when it cools or when a liquid vehicle evaporates, to incorporate the attachment member into the body of the fish-attractant product, such as may be done using the second method set forth above, using the active attractant material and a hardenable release material. In this way, the product, when formed, will include a body with an integrally formed attachment member 44 extending from the body. If desired, an eyelet or loop 46 may be pre-formed at the free end of the attachment member 44 extending from the body of the fish-attractant product.

When the product mixture is formed into a fish-attractant product by a pressurized or compressive technique, such as in a pressurized mold or a tablet press, the product mixture is then compressed in the mold or press at a sufficient force or pressure to obtain a fish-attractant product having the fish-attractant material releasable times and dissolution times described above. Release and dissolution times may be determined empirically without undue experimentation in view of the present disclosure, based on the type, characteristics and concentration of the fish-attractant material used as the active ingredient(s), the nature, type and concentration of the release material, such as the cellulose derivative polymer which functions as a releasing agent for the fish-attractant material, and the force or pressure used to compress the product mixture to form the fish-attractant product. Typical pressures used to form a suitable product in the shape of a bullet-shaped body having a weight of about 1.5 grams, using about 25% of fish-attractant material in the form of one or more amino acids and about 15% of HPMC as the cellulose derivative polymer, is about 10,000 psi (703 kg/cm²) to about 22,500 psi (1,582 kg/cm²). The particular formulation ingredients and amounts may be varied as mentioned above to form the fish-attractant product having the characteristics, benefits and advantages using this broad range of compression forces. A preferred compression force range is about 13,000 psi (914 kg/cm²) to about 16,000 psi (1,125 kg/cm²). A more preferred compression force is about 14,000 psi (984 kg/cm²) to about 15,000 psi (1,055 kg/cm²).

Another factor in the releasability of the fish-attractant material and the dissolution of the product in water is the hardness, or more accurately, the peak crush strength, of the compressed product. The peak crush strength is measured by compressing the product between flat plates in a testing device and measuring the compression force exerted until the product is crushed, such as a Dr. Schleuniger Pharmatron® Model 6D test apparatus available from Dr. Schleuniger Pharmatron, Inc. of Manchester, N.H., USA, using Method No. M75.2. The test method is suitable for tablets or other shaped products having a maximum diameter of one inch (2.54 cm) and no more than 45 kp in peak crush strength. In general, the fish-attractant product should have a peak crush strength of about 25 kilopond (kp) to about 40 kp, preferably about 30 kp to about 35 kp, and more preferably about 30 kp to about 33 kp. Fish-attractant products according to this invention with a peak crush strength in these ranges should have the desired releasability and dissolution characteristics set forth herein.

As mentioned above, the dissolution rate of the dissolvable fish-attractant product, which affects the release rate of the fish-attractant material used as the active ingredient, is an important characteristic of the present invention. The dissolution of the fish-attractant product 10 preferably should provide a substantially uniform release of the fish-attractant material throughout the life of the product until the product is substantially completely dissolved. The preferred dissolution and release times are also as set forth above. This provides a suitable period for attracting fish without having to replace the product on the fishing line without wasting material. Moreover, providing a product which dissolves completely in water allows a ready visual indication of about how much time is left for fishing with the product before it must be replaced.

Upon completion of the manufacturing process, the fish-attractant products of this invention should be stored and packaged in a manner to avoid wetting them or subjecting them to high humidity. It is preferred that the products be packaged in blister packages, such that each individual product would be sealed in its own blister receptacle within the blister package. In this way, each individual product is fresh and is less likely to be damaged at the time of use.

The present invention also includes a method of fishing using the fish-attractant product of the present invention, as noted above. Accordingly, this method of fishing comprises indirectly or preferably, directly attaching to a fishing line ahead of a lure or a baitable hook, the fish-attractant product as described above. The fish-attractant product is adapted in use not to be swallowed by a fish, yet the fish-attractant material during use provides a fish-attracting scent or taste, or both scent and taste, through complete dissolution of the body of the product that facilitates catching fish. Preferably, both olfactory and gustatory fish-attractant materials are used in the fish-attractant product. This method is illustrated using the arrangements shown in the embodiments of FIGS. 2, 9, 11 and 12. In FIG. 2, the fish-attractant product 10 is threaded directly on a fishing line 16 preferably immediately ahead of the lure 18 with the hook 26. In FIG. 9, the fish-attractant product 10 is attached to the fishing line 16 by the attachment member 44 and the loop or knot 46 preferably immediately ahead of the lure 18 with the hook 26. Instead of an arrangement using the attachment member 44, the fish-attractant product 10 could be removably attached to a line lock device, such as the embodiments of line lock devices 44′ and 44″ shown in FIGS. 11 and 12, respectively.

### EXAMPLES

The invention will now be described in more detail with reference to the following specific, non-limiting Examples.

### Examples 1-5

### Compositions

Using the method described above, the following examples of a fish-attractant product according to the present invention were prepared, using a Carver® tableting press at a compression pressure of about 15,000 psi. (1,055 kg/cm²), in the form of cylinder-shaped tablets or pellets having a diameter of about diameter of 13 mm (0.5 in.) and a thickness of 9 mm (0.35 in.), and a weight of about 1.8 grams.

### Example 1

| Ingredient | % Composition |
|---|---|
| Lactose | 57 |
| Amino Acids (Total) | 25 |
| L-Alanine | 5 |
| L-Arginine | 5 |
| L-Proline | 5 |
| Aspartic Acid | 5 |
| Glutamic Acid | 5 |
| Red Dye #40 | 2 |
| Methocel K 100 LV | 15 |
| Magnesium Stearate | 1 |
| TOTAL: | 100 |

### Example 2

| Ingredient | % Composition |
|---|---|
| Calcium Hydrogen | 57 |
| Phosphate Dihydrate | |
| Amino Acids (Total) | 25 |
| L-Alanine | 5 |
| L-Arginine | 5 |
| L-Proline | 5 |
| Aspartic Acid | 5 |
| Glutamic Acid | 5 |
| Red Dye #40 | 2 |
| Methocel K 100 LV | 15 |
| Magnesium Stearate | 1 |
| TOTAL: | 100 |

### Example 3

| Ingredient | % Composition/tablet |
|---|---|
| Calcium Hydrogen Phosphate Dihydrate | 59 |
| Amino Acid (Total) | 25 |
| L-Alanine | 5 |
| L-Arginine | 5 |
| L-Proline | 5 |
| Aspartic Acid | 5 |
| Glutamic Acid | 5 |
| Methocel K 100 LV | 15 |
| Magnesium Stearate | 1 |
| TOTAL: | 100 |

### Example 4

| Ingredient | % Composition/tablet |
|---|---|
| Lactose | 59 |
| Amino Acid (Total) | 25 |
| L-Alanine | 5 |
| L-Arginine | 5 |
| L-Proline | 5 |
| Aspartic Acid | 5 |
| Glutamic Acid | 5 |
| Methocel K 100 LV | 15 |
| Magnesium Stearate | 1 |
| TOTAL: | 100 |

### Example 5

| Ingredients | % |
|---|---|
| Lactose | 56.5 |
| Amino Acid (Total) | 25 |
| L-Alanine | 5 |
| L-Arginine | 5 |
| L-Proline | 5 |
| Aspartic Acid | 5 |
| Glutamic Acid | 5 |
| Red Dye #40 Aluminum Lake | 2 |
| Methocel K 100 LV | 15 |
| Cabosil M5 (fumed silica) | 0.2 |
| Stearic Acid | 0.7 |
| Magnesium Stearate | 0.6 |

### Examples 6-14

### Compositions with Dissolution Times

The following additional fish-attractant products identified in Table 2 were made and tested according to the methods and Examples set forth above. More specifically, dissolution times for various exemplary fish-attractant products made using the present invention have been calculated experimentally and included in the following Table 2, to determine the dissolution rate of the product in the form of cylinder-shaped tablets or pellets having a weight of about 1.8 g, a diameter of 13 mm (0.5 in.) and a thickness of 9 mm (0.35 in.). The dissolution rate was measured in water that is flowing past the product at a simulated rate of about 1 to about 2 feet (about 0.35 to about 0.7 meters) per second. The rate was chosen as a simulation of the flow rate likely to be encountered during the retrieval of a fishing lure. The product was suspended in a transparent tube by a copper wire and supported by a copper mesh in a moving stream of water flowing at a rate of about 170 mL per second.

TABLE 1

| Example # | Ingredients | Compression | Dissolution Time | Comments |
|---|---|---|---|---|
| 6 | 8.3% L-proline | 20,000 psi | 14 min. | Hydroscopic: flakes |
| | 8.3% L-alanine | (1,406 kg/cm²) | 49 secs. | when handled if left |
| | 8.3% L-arginine | | | 12 hrs. in open air; |
| | 15% Methocel K3 LV | | | okay if sealed |
| | 59% Lactose | | | |
| | 1% Magnesium | | | |
| | Stearate | | | |
| 7 | 8.3% L-proline | 15,000 psi | 16 min. | Anise scent added to |
| | 8.3% L-alanine | (1,055 kg/cm²) | 0 secs. | excipient prior to |
| | 8.3% L-arginine | | | blending |
| | 15% Methocel K3 LV | | | |
| | 59% CaHPO₄.2H₂O | | | |
| | 1% Magnesium | | | |
| | Stearate | | | |
| 8 | 8.3% L-proline | 15,000 psi | 46 min. | |
| | 8.3% L-alanine | (1,055 kg/cm²) | 0 sec. | |
| | 8.3% L-arginine | | | |
| | 15% Methocel 100LV | | | |
| | CR | | | |
| | 59% CaHPO₄.2H₂O | | | |
| | 1% Magnesium | | | |
| | Stearate | | | |
| 9 | 8.3% L-proline | 15,000 psi | 32 min. | Anise scent added to |
| | 8.3% L-alanine | (1,055 kg/cm²) | 0 sec. | excipient prior to |
| | 8.3% L-arginine | | | blending |
| | 10% Methocel 100 LV | | | |
| | CR | | | |
| | 5% Methocel K3 LV | | | |
| | 59% CaHPO₄.2H₂O | | | |
| | 1% Magnesium | | | |
| | Stearate | | | |
| 10 | 8.3% L-proline | 15,000 psi | 22 min. | Anise scent added to |
| | 8.3% L-alanine | (1,055 kgcm²) | 50 sec. | excipient prior to |
| | 8.3% L-arginine | | | blending |
| | 5% Methocel 100 LV | | | |
| | CR | | | |
| | 59% CaHPO₄.2H₂O | | | |
| | 1% Magnesium | | | |
| | Stearate | | | |
| 11 | 8.3% L-proline | 15,000 psi | 27 min. | |
| | 8.3% L-alanine | (1,055 kg/cm²) | 45 sec. | |
| | 8.3% L-arginine | | | |
| | 12% Methocel K3 LV | | | |
| | 3% Methocel K75M | | | |
| | 59% CaHPO₄.2H₂O | | | |
| | 1% Magnesium | | | |
| | Stearate | | | |
| 12 | 8.3% L-proline | 15,000 psi | 26 min. | |
| | 8.3% L-alanine | (1,055 kg/cm²) | | |
| | 8.3% L-arginine | | | |
| | 10% Methocel K3 LV | | | |
| | 5% Methocel K75M | | | |
| | 59% CaHPO₄.2H₂O | | | |
| | 1% Magnesium | | | |
| | Stearate | | | |
| 13 | 8.3% L-proline | 15,000 psi | 35 min. | |
| | 8.3% L-alanine | (1,055 kg/cm²) | | |
| | 8.3% L-arginine | | | |
| | 8.5% Methocel K3 LV | | | |
| | 6.5% Methocel K75M | | | |
| | 59% CaHPO₄.2H₂O | | | |
| | 1% Magnesium | | | |
| | Stearate | | | |
| 14 | 8.3% L-proline | 15,000 psi | 81 min. | |
| | 8.3% L-alanine | (1,055 kg/cm²) | | |
| | 8.3% L-arginine | | | |
| | 7.5% Methocel K3 LV | | | |
| | 7.5% Methocel K75M | | | |
| | 59% CaHPO₄.2H₂O | | | |
| | 1% Magnesium | | | |
| | Stearate | | | |

### Example 15

### Effect of Type of Cellulose Derivative on Dissolution

The effect of the type of cellulose derivative polymer used on dissolution time was tested, using the Methocel® cellulose ethers shown in the following Table 1, producing 2 gram fish-attractant products in the form of cylinder-shaped tablets having a diameter of 13 mm (0.5 in.), and a thickness of 9 mm (0.35 in.) made using a Carver® tableting press, and having the indicated dissolution times. The fish-attractant products included 15% of the Methocel® (product, 25% of fish-attractant material in equal amounts of L-alanine, L-arginine and L-proline, 1% of magnesium stearate tableting aid, and 59% of lactose excipient.

TABLE 2

| Methocel ® Product | Dissolution Time |
|---|---|
| E3 | 11 minutes |
| E15 | 20 minutes |
| E50 | 5 minutes |
| F50 | 20 minutes |
| F4M | 25 minutes |
| K100LV | 30 minutes |
| K100LV CR | 29 minutes |

### Example 16

### Effect of Compression Force on Dissolution

Since the compression force affects the thickness of the fish-attractant product in the form of the experimental tablets described above, and also their dissolution time, an experiment was done to determine the effect of the relative compression force on tablet thickness and the time to dissolve the tablets. The composition used to test the effect of compression force on dissolution time contained only 20% Methocel® K3 Premium LV cellulose either derivative and 80% MgSO₄.7H₂O. These results are set forth in the following Table 3.

TABLE 3

| Tablet | Relative Compression | | Time to |
|---|---|---|---|
| ID | Force | Tablet Thickness | Dissolve |
| 1 | 6,000 psi (422 kg/cm²) | 0.43 in. (11 mm) | 8 min. 45 sec. |
| 2 | 7,000 psi (492 kg/cm²) | 0.41 in. | 14 min. 18 sec. |
| | | (10.5 mm) | |
| 3 | 10,000 psi (703 kg/cm²) | 0.39 in (10 mm) | 18 min. 30 sec. |
| 4 | 15,000 psi (1,055 kg/cm²) | 0.39 in (10 mm) | 26 min. 13 sec. |
| 5 | 20,000 psi (1,406 kg/cm²) | 0.35 in (9 mm) | 21 min. 0 sec. |
| 6 | 25,000 psi (1,758 kg/cm²) | 0.37 in (9.5 mm) | 28 min. 39 sec. |

### Example 17

### Effectiveness Study

A study was conducted to determine whether and the extent to which the fish-attractant product of the present invention attracts fish using a sample of fish available within a trout hatchery. The product of the study was the product described above in Example 4. The study included repetitive blind tests in which the trout were introduced to both the product and to a placebo. When compared to the placebo, the invention product attracted more fish to hit and more fish to hit repetitively.

The study took place at a trout hatchery in Allentown, Pa., U.S.A., when the air temperature was in the high 20's (° F.) with sporadic light snow flurries. To minimize subject variability, fish from a single hatchery run were used in all experimental replications. The run was approximately 250 feet in length, with fish free to roam its entire length. Those fish that that came within camera range of a fixed camera were used as subjects. Those fish that reacted to either tablet (placebo or product) were counted. During the study, persons not associated with the study and waterfowl were kept out of the area in which the study was being conducted.

Observers counted the number of fish, during 10-minute test periods, which touched (mouthed, nudged, engulfed, bit, etc.) the sample tablet. If the same fish touched the sample multiple times within the same period, the observer counted the occurrence as one fish hit. Fish leaving camera range and then returning were considered as new fish. Only contact by the mouth of a fish was counted.

Observers also counted the number of fish, during the 10-minute test period that touched (mouthed, nudged, engulfed, bit, etc.) the sample tablet multiple times within the same period. Fish leaving camera range and then returning were considered as new fish. Again, only contact by the mouth of a fish was counted.

The invention product was compared to a placebo. The placebo tablet was in all attributes (shape, size, weight, texture, etc.) identical to the product tablet except it lacked the fish-attractant material ingredients contained in the product.

As data were in the form of frequency counts (fish hits, repetitive fish hits), a non-parametric statistical test was appropriate. The number of fish hits associated with the product and the placebo were compared during four separate 10-minute test periods. The process was repeated using repetitive fish hits as the dependent variable.

Prior to actual testing, sample tablets (product, placebo) where randomly assigned to each test and labeled 1A, 1B, 2A, 2B, 3A, 3B, 4A, 4B, where the numbers 1 to 4 represented experimental replications and the letters A and B represented the random assignment of the sample tablet between product and placebo. The legend was placed into a sealed envelope and given to an independent investigator before tests began. This information was not shared with the investigator, or the observers, until actual counts were performed and provided to the investigator. The investigator used the legend to complete the statistical analyses.

The hatchery run was transversed (within view of the fixed camera) by a length of monofilament from which was suspended a 40-inch monofilament strand and to which a sample tablet was directly tied through a hole in the tablet. In each of the eight tests, observers blindly (unknown if product or placebo) tied a tablet directly to the end of the monofilament, tossed the tablet into the hatchery run, checked the camera, and exited to observation points in excess of fifty feet from the camera and hatchery run. They maintained this distance until a test was completed (approximately 15 minutes).

Each test was executed according to the procedures above and a period of 5 minutes was allowed to permit acclimation. The actual test began at the end of this 5-minute acclimation period and lasted for ten minutes. In this manner, eight tests were conducted. Each of the eight tests was separately filmed and each film was given to the investigator for secure keeping. In the presence of the investigator, each tape was transferred to VCR tape media to enable observers to count fish hits and repetitive fish hits. The copied tapes, the ones from which the observers would count, were retained by the investigator for posterity.

Prior to actual counting by the observers, all observers were provided operational data definitions of fish hits and repetitive fish hits. Each observer then watched a 3-minute video tape, containing similar activity by similar subjects, and completed the observation form. This process was repeated until the largest count deviation among the observers was less than 10 percent. In practice, it was decided to use two 2-person observer teams. One observer counted the number of fish hits, and another independent observer counted the number of repetitive fish hits. These observations (hit, repetitive) were verbally communicated to two observers who recorded results. If recorded counts differed, the mean observed frequency (rounded upward to the nearest whole number) was used.

The observers simultaneously viewed each of the VCR tapes of the eight tests and completed their observation sheets. The order in which the tapes were reviewed by the observers for counting was randomly assigned by the investigator. In this manner no one but the investigator knew what test (1, 2, 3, . . . 8) was being observed, and the investigator had no knowledge if a test was a product or a placebo sample tablet. The investigator assured that at all times (experiment, testing, observation, counting) participants were blind as to whether the sample tablet being counted was the product or the placebo. Completed, signed, labeled, tally sheets were provided to the investigator who formed a master sheet for each test. Master sheet results were stored on tape.

Eight tests were performed with results recorded onto film. Frequency counts, based upon viewing the recorded tapes, were tabulated by two independent teams. Observers were blind as to whether the tape being counted was the product or a placebo. In one test tape, quality was poor and in another, very few fish were attracted to the tablet. It is believed that the study's results were not biased by these occurrences and as such, all eight tests were included in the study.

A separate chi square test for independent samples was calculated for each of the two dependent variables: number of fish hits (χ2=49.42; p<0.00001); number of repetitive fish hits (χ2=34.46; p<0.00001). Each chi square was represented by a 4×2 contingency table (df=3) with all expected cell frequencies exceeding 5.

The results of the study are as follows:

| | Invention | Placebo | Difference |
|---|---|---|---|
| Total number of fish hitting the sample | 381 | 160 | 138% |
| Total number of repetitive hits | 218 | 62 | 252% |

It is highly unlikely that the observed differences between the product and the placebo could occur by random chance. Even a conservative conclusion would be that the product attracted significantly more fish than the placebo as measured by the number of fishing hitting a tablet and by the number of fish repetitively hitting a tablet.

### Example 18

### Study of Hits Using a Soft Plastic Lure

A separate study was conducted at the same hatchery as used in the study of Example 16 and was similar to that of Example 17, except that the study was to compare hits on a soft plastic lure in the presence of the invention product of Example 4 or a placebo not containing the active fish-attractant materials of Example 4, and an independent investigator was not used. This study had the following results:

| | Invention | Placebo | Difference |
|---|---|---|---|
| Total number of hits | 265 | 153 | 73% |

This study provides independent statistical confirmation that the invention product attracts fish, solicits more hits and that it receives more repetitive hits. This has been verified by this experimental design including a controlled environment with a quantity of fish and randomly introducing the fish to one of two samples, the product and a placebo with a typical soft bait plastic lure, and counting the number of fish during a specified time period that “hit” the product or the placebo. Clearly, use of the fish-attractant product of the present invention resulted in very significantly more hits than the placebo.

### Example 19

### Study of Hits and Catches Using Live Bait

A separate study was conducted comparing hits in the presence of the invention product or a placebo with live bait on a large hook (to avoid having the fish swallow the hook, potentially resulting in greater fish kill than intended when the hook was removed from the mouth of the fishes). The study was conducted in the Sassafras River in Galena, Md., U.S.A. Two fishermen were involved. One was using the product of this invention as disclosed in Example 4. Neither fisherman knew whether he was using the product or the placebo, though the inventor, who was the person who assigned the product or placebo to the fishermen and who did the counting of the hits knew which fisherman was using the product or the placebo. Even though an independent investigator was not involved, the hits were counted fairly and in a consistent manner with respect to each fisherman. The other was using the same bait and the same hook arrangement, except that a placebo was used instead of the product containing the active fish-attractant materials. This study had the following results:

| | Invention | Placebo | Difference |
|---|---|---|---|
| Total number of hits (*) | 46 | 21 | 119% |
| Total fish caught (*) | 6 | 1 | 600% |

This study provides statistical confirmation that the invention product attracts fish, receives more hits and that it receives more repetitive hits. This has been verified by this experimental design including a controlled environment with a quantity of fish and randomly introducing the fish to one of two treatments, the product and a placebo with live bait on large hooks to count bites but not necessarily to reel in fish. Using larger hooks resulted in lower mortality. The number of fish during a specified time period that “hit” the product or the placebo were counted. The number of fish during a specified time period that were caught using the product or the placebo were also counted. Clearly, use of the fish-attractant product of the present invention resulted in very significantly more hits and catches than the placebo.

It will be appreciated by those skilled in the art in view of the present disclosure that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A fish-attractant product comprising a body preformed into a predetermined shape from a material dissolvable in water comprising at least one of an olfactory fish-attractant material and a gustatory fish-attractant material that is releasable in water in which the product is immersed, the body being made of a composition comprising the fish-attractant material in an amount to be releasable in water for a period of time of about 15 minutes to about 60 minutes and a cellulose derivative polymer in an amount such that the body is dissolvable in water over a period of time of about 15 minutes to about 60 minutes, the product being adapted in use not to be swallowed by a fish and being attachable at least one of directly and indirectly to a fishing line ahead of at least one of a lure and a baitable hook, such that the fish-attractant material during use provides at least one of a fish-attracting odor and a taste through dissolution of the body that facilitates catching fish.

2. The product of claim 1, wherein the body is adapted to be attached directly to a fishing line immediately ahead of at least one of the lure and hook, such that at least one of the odor and the taste of the fish-attractant material pervades an area around at least one of the lure and the hook.

3. The product of claim 1, wherein the body has a bore extending therethrough and wherein the body has a shape selected from the group consisting of a sphere, a cylinder, a bullet-like shape, an ellipsoid, an ovoid, and a cone.

4. The product of claim 1, wherein the body has a bullet-like shape with a longitudinal axis, a hydrodynamic front and an opposed rear, with a bore extending through the body between the front and rear and along the axis for receiving therethrough one of the fishing line and an attachment member, the attachment member being attachable to the fishing line, the front adapted to be a leading end in the direction of travel in which at least one of the lure and the hook is pulled through the water to reduce fluid resistance against the body.

5. The product of claim 1, wherein the olfactory fish-attractant material comprises at least one of alanine, arginine, aspartic acid, glutamic acid, cysteine, histidine, methionine, serine, phenylalanine, betaine, glycine, inosine, taurine, lysine, purine, pterin, bile acid, glutamate, glutamine, leucine, taurine, and mixtures thereof.

6. The product of claim 1, wherein the gustatory fish-attractant material comprises at least one of proline, cysteine, histidine, methionine, serine, phenylalanine, betaine, glycine, inosine, alanine, taurine, lysine, purine, pterin, bile acid, glutamate, glutamine, leucine, taurine, praline, and mixtures thereof.

7. The product of claim 1, wherein the fish-attractant material comprises at least one amino acid.

8. The product of claim 7, wherein the amino acid is at least one of L-alanine and L-arginine.

9. The product of claim 8, wherein the fish-attractant material comprises a mixture of L-alanine and L-arginine.

10. The product of claim 9, wherein the fish-attractant material further comprises L-proline.

11. The product of claim 10, wherein the fish-attractant material further comprises at least one of aspartic acid and glutamic acid.

12. The product of claim 1, wherein the body has a peak crush strength of about 25 kp to about 40 kp.

13. The product of claim 12, wherein the body has a peak crush strength of about 30 kp to about 35 kp.

14. The product of claim 13, wherein the body has a peak crush strength of about 30 kp to about 33 kp.

15. The product of claim 1, wherein the fish-attractant material is releasable a period of time of about 30 minutes to about 45 minutes and the body is dissolvable over a period of time of about 30 minutes to about 45 minutes.

16. The product of claim 15, wherein the fish-attractant material is releasable a period of time of about 40 minutes and the body is dissolvable over a period of time of about 40 minutes.

17. The product of claim 1, wherein the fish-attractant material comprises at least one amino acid and the fish-attractant material is present in an amount of about 1% to about 75%, and the cellulose derivative polymer is present in an amount of about 1% to about 40%.

18. The product of claim 17, wherein the fish-attractant material comprises a mixture of at least two amino acids and the fish-attractant material is present in an amount of about 10% to about 30%, and the cellulose derivative polymer is present in an amount of about 10% to about 30%.

19. The product of claim 1, wherein the body further comprises at least one of (a) at least one excipient, (b) at least one tableting aid, and (c) at least one colorant.

20. The product of claim 19, wherein the fish-attractant material comprises a mixture of at least two amino acids and the fish-attractant material is present in an amount of about 25%, the cellulose derivative polymer is present in an amount of about 15%, the tableting aid is present in an amount of about 1%, the balance being the excipient and optionally, a colorant sufficient to provide a desired color.

21. The product of claim 20, wherein the fish-attractant material comprises approximately equal amounts of L-alanine, L-arginine and L-proline.

22. The product of claim 19, wherein the cellulose derivative polymer is selected from the group consisting of methylcellulose (MC), hydroxyethyl cellulose (HEC), hydroxypropyl methylcellulose (HPMC, also known as hypromellose), hydroxypropyl cellulose (HPC), methylhydroxy propylcellulose (MHPC), ethyl hydroxyethyl cellulose (EHEC), methylhydroxy butylcellulose (MHBC), carboxymethyl cellulose (CMC), carboxymethyl methylcellulose (CMMC), hydroxyethyl hydroxypropyl methyl cellulose (HEHPMC) and methyl hydroxyethyl cellulose (MHEC), and mixtures thereof, the tableting aid is selected from the group consisting of calcium stearate, magnesium stearate, stearic acid, zinc stearate, sodium stearyl fumarate, ascorbyl palmitate, micronized or non micronized talc, silica in various forms such as fumed silica, colloidal silica and precipitated silica and silica gel, sodium aluminum silicate, mineral calcium with stearic acid, glyceryl monostearate, glyceryl triacetate, hydroxypropyl methylcellulose pthalate (HPMCP), maltodextrin, octadecnonic acid, polyethylene glycol, shellac and especially purified shellac, soapstone, sodium benzoate, sodium lauryl sulfate, titanium dioxide, boric acid, sodium chloride, mineral oil and hydrogenated vegetable oil, and mixtures thereof, and the excipient is selected from the group consisting of precipitated calcium carbonate, monobasic calcium phosphate, dibasic calcium phosphate, calcium hydrogen phosphate dihydrate, calcium hydrogen phosphate dehydrate, tribasic calcium phosphate, calcium sulfate, magnesium sulfate, microcrystalline cellulose, powdered cellulose, dextrose, kaolin, lactose, sorbitol, magnesium carbonate, magnesium sulfate, mannitol, sodium chloride, starch, pregelantinized starch, sucrose, compressible sugar and confectioner's sugar, and mixtures thereof.

23. The product of claim 22, wherein the fish-attractant material comprises approximately equal amounts of L-alanine, L-arginine and L-proline; the cellulose derivative polymer is HPMC, the tableting aid is selected from the group consisting of magnesium stearate and stearic acid, and the excipient is selected from the group consisting of lactose and calcium hydrogen phosphate dihydrate.

24. The product of claim 23, wherein the fish-attractant material comprises L-alanine, L-arginine, L-proline, aspartic acid and glutamic acid in equal amounts; the cellulose derivative is HPMC having a pH of about 5.5 to about 8.0, a methoxyl content of about 19% to about 24%, an apparent viscosity in a 2% aqueous solution at 20° C. of about 78 mPa.s to about 117 mPa.s when measured by a rotation method and about 80 cP to about 120 cP when measured by a Ubbelhode method; the tableting agent is magnesium stearate; the excipient is selected from the group consisting of lactose and calcium hydrogen phosphate dihydrate; and the colorant is selected from the group consisting of red dye #40 and FD&C Aluminum Lake #40.

25. A method of fishing comprising attaching at least one of directly and indirectly to a fishing line ahead of at least one of a lure and a baitable hook, a fish-attractant product comprising a body preformed into a predetermined shape from a material dissolvable in water comprising at least one of an olfactory fish-attractant material and a gustatory fish-attractant material that is releasable in water in which the product is immersed, the body being made of a composition comprising the fish-attractant material in an amount to be releasable in water for a period of time of about 15 minutes to about 60 minutes and a cellulose derivative polymer in an amount such that the body is dissolvable in water over a period of time of about 15 minutes to about 60 minutes, the product being adapted in use not to be swallowed by a fish and being attachable at least one of directly and indirectly to a fishing line ahead of at least one of the lure and the hook, such that the fish-attractant material during use provides at least one of a fish-attracting odor and a taste through dissolution of the body that facilitates catching fish.

26. The method of claim 25, wherein the body is adapted to be attached directly to a fishing line immediately ahead of at least one of the lure and hook, such that at least one of the odor and the taste of the fish-attractant material pervades an area around at least one of the lure and the hook.

27. The method of claim 25, wherein the body has a bore extending therethrough and is attached to a line lock device, and the line lock device is attached to the fishing line immediately ahead of at least one of the lure and the hook.

28. The method of claim 25, wherein the body has a bore extending therethrough and wherein the body has a shape selected from the group consisting of a sphere, a cylinder, a bullet-like shape, an ellipsoid, an ovoid, and a cone.

29. The method of claim 25, wherein the body has a bullet-like shape with a longitudinal axis, a hydrodynamic front and an opposed rear, with a bore extending through the body between the front and rear and along the axis for receiving therethrough one of the fishing line and an attachment member, the attachment member being attachable to the fishing line, the front adapted to be a leading end in the direction of travel in which at least one of the lure and the hook is pulled through the water to reduce fluid resistance against the body.

30. The method of claim 25, wherein the olfactory fish-attractant material comprises at least one of alanine, arginine, aspartic acid, glutamic acid, cysteine, histidine, methionine, serine, phenylalanine, betaine, glycine, inosine, taurine, lysine, purine, pterin, bile acid, glutamate, glutamine, leucine, taurine, and mixtures thereof.

31. The method of claim 25, wherein the gustatory fish-attractant material comprises at least one of proline, cysteine, histidine, methionine, serine, phenylalanine, betaine, glycine, inosine, alanine, taurine, lysine, purine, pterin, bile acid, glutamate, glutamine, leucine, taurine, praline, and mixtures thereof.

32. The method of claim 25, wherein the fish-attractant material comprises at least one amino acid.

33. The method of claim 32, wherein the amino acid is at least one of L-alanine and L-arginine.

34. The method of claim 33, wherein the fish-attractant material comprises a mixture of L-alanine and L-arginine.

35. The method of claim 34, wherein the fish-attractant material further comprises L-proline.

36. The method of claim 35, wherein the fish-attractant material further comprises at least one of aspartic acid and glutamic acid.

37. The method of claim 25, wherein the body has a peak crush strength of about 25 kp to about 40 kp.

38. The method of claim 37, wherein the body has a peak crush strength of about 30 kp to about 35 kp.

39. The method of claim 38, wherein the body has a peak crush strength of about 30 kp to about 33 kp.

40. The method of claim 25, wherein the fish-attractant material is releasable a period of time of about 30 minutes to about 45 minutes and the body is dissolvable over a period of time of about 30 minutes to about 45 minutes.

41. The method of claim 40, wherein the fish-attractant material is releasable a period of time of about 40 minutes and the body is dissolvable over a period of time of about 40 minutes.

42. The method of claim 25, wherein the fish-attractant material comprises at least one amino acid and the fish-attractant material is present in an amount of about 1% to about 75%, and the cellulose derivative polymer is present in an amount of about 1% to about 40%.

43. The method of claim 42, wherein the fish-attractant material comprises a mixture of at least two amino acids and the fish-attractant material is present in an amount of about 10% to about 30%, and the cellulose derivative polymer is present in an amount of about 10% to about 30%.

44. The method of claim 25, wherein the body further comprises at least one of (a) at least one excipient, (b) at least one tableting aid, and (c) at least one colorant.

45. The method of claim 44, wherein the fish-attractant material comprises a mixture of at least two amino acids and the fish-attractant material is present in an amount of about 25%, the cellulose derivative polymer is present in an amount of about 15%, the tableting aid is present in an amount of about 1%, the balance being the excipient and optionally, a colorant sufficient to provide a desired color.

46. The method of claim 45, wherein the fish-attractant material comprises approximately equal amounts of L-alanine, L-arginine and L-proline.

47. The method of claim 44, wherein the cellulose derivative polymer is selected from the group consisting of methylcellulose (MC), hydroxyethyl cellulose (HEC), hydroxypropyl methylcellulose (HPMC, also known as hypromellose), hydroxypropyl cellulose (HPC), methylhydroxy propylcellulose (MHPC), ethyl hydroxyethyl cellulose (EHEC), methylhydroxy butylcellulose (MHBC), carboxymethyl cellulose (CMC), carboxymethyl methylcellulose (CMMC), hydroxyethyl hydroxypropyl methyl cellulose (HEHPMC) and methyl hydroxyethyl cellulose (MHEC), and mixtures thereof, the tableting aid is selected from the group consisting of calcium stearate, magnesium stearate, stearic acid, zinc stearate, sodium stearyl fumarate, ascorbyl palmitate, micronized or non micronized talc, silica in various forms such as fumed silica, colloidal silica and precipitated silica and silica gel, sodium aluminum silicate, mineral calcium with stearic acid, glyceryl monostearate, glyceryl triacetate, hydroxypropyl methylcellulose pthalate (HPMCP), maltodextrin, octadecnonic acid, polyethylene glycol, shellac and especially purified shellac, soapstone, sodium benzoate, sodium lauryl sulfate, titanium dioxide, boric acid, sodium chloride, mineral oil and hydrogenated vegetable oil, and mixtures thereof, and the excipient is selected from the group consisting of precipitated calcium carbonate, monobasic calcium phosphate, dibasic calcium phosphate, calcium hydrogen phosphate dihydrate, calcium hydrogen phosphate dehydrate, tribasic calcium phosphate, calcium sulfate, magnesium sulfate, microcrystalline cellulose, powdered cellulose, dextrose, kaolin, lactose, sorbitol, magnesium carbonate, magnesium sulfate, mannitol, sodium chloride, starch, pregelantinized starch, sucrose, compressible sugar and confectioner's sugar, and mixtures thereof.

48. The method of claim 47, wherein the fish-attractant material comprises approximately equal amounts of L-alanine, L-arginine and L-proline; the cellulose derivative polymer is HPMC, the tableting aid is selected from the group consisting of magnesium stearate and stearic acid, and the excipient is selected from the group consisting of lactose and calcium hydrogen phosphate dihydrate.

49. The method of claim 48, wherein the fish-attractant material comprises L-alanine, L-arginine, L-proline, aspartic acid and glutamic acid in equal amounts; the cellulose derivative is HPMC having a pH of about 5.5 to about 8.0, a methoxyl content of about 19% to about 24%, an apparent viscosity in a 2% aqueous solution at 20° C. of about 78 mPa.s to about 117 mPa.s when measured by a rotation method and about 80 cP to about 120 cP when measured by a Ubbelhode method; the tableting agent is magnesium stearate; the excipient is selected from the group consisting of lactose and calcium hydrogen phosphate dihydrate; and the colorant is selected from the group consisting of red dye #40 and FD&C Aluminum Lake #40.

50. A method of making a fish-attractant product comprising:
(a) mixing until thoroughly blended, to form a product mixture, ingredients comprising
(i) fish-attractant material in an amount to be releasable in water for a period of time of about 15 minutes to about 60 minutes,
(ii) a cellulose derivative polymer in an amount such that the body is dissolvable in water over a period of time of about 15 minutes to about 60 minutes, and optionally
(iii) at least one excipient,
(iv) at least one tableting aid, and
(v) at least one colorant; and
(b) forming the product mixture into a fish-attractant product having a dissolution time in water of about 15 minutes to about 60 minutes and a peak crush strength of about 25 kp to about 40 kp.

51. The method of claim 50, wherein the forming step (b) comprises:
(i) forming the fish-attractant product by compressing the product mixture in a compression device comprising one of a mold and a press at a pressure sufficient to result in a fish-attractant product having the recited dissolution time and peak crush strength; and
(ii) removing the fish-attractant product from the compression device.

52. The method of claim 51, wherein the compression pressure is about 10,000 psi (703 kg/cm²) to about 22,500 psi (1,582 kg/cm²).

53. The method of claim 52, wherein the compression pressure is about 13,000 psi (914 kg/cm²) to about 16,000 psi (1,125 kg/cm²).

54. The method of claim 53, wherein the compression pressure is about 14,000 psi (984 kg/cm²) to about 15,000 psi (1,055 kg/cm²).

55. The method of claim 50, wherein the releasable time and the dissolution time are about 30 minutes to about 45 minutes.

56. The method of claim 50, wherein the releasable time and the dissolution time are about 40 minutes.

57. The method of claim 50, wherein the fish-attractant product has a peak crush strength of about 30 kp to about 35 kp.

58. The method of claim 57, wherein the fish-attractant product has a peak crush strength of about 30 kp to about 33 kp.

59. The method of claim 50, wherein the fish-attractant material comprises at least one amino acid and the fish-attractant material is present in an amount of about 1% to about 75%, and the cellulose derivative polymer is present in an amount of about 1% to about 40%.

60. The method of claim 59, wherein the fish-attractant material comprises a mixture of at least two amino acids and the fish-attractant material is present in an amount of about 10% to about 30%, and the cellulose derivative polymer is present in an amount of about 10% to about 30%.

61. The method of claim 50, wherein the fish-attractant material comprises a mixture of at least two amino acids and the fish-attractant material is present in an amount of about 25%, the cellulose derivative polymer is present in an amount of about 15%, the tableting aid is present in an amount of about 1%, the balance being the excipient and optionally, a colorant sufficient to provide a desired color.

62. The method of claim 61, wherein the fish-attractant material comprises approximately equal amounts of L-alanine, L-arginine and L-proline.

63. The method of claim 50, wherein the cellulose derivative polymer is selected from the group consisting of methylcellulose (MC), hydroxyethyl cellulose (HEC), hydroxypropyl methylcellulose (HPMC, also known as hypromellose), hydroxypropyl cellulose (HPC), methylhydroxy propylcellulose (MHPC), ethyl hydroxyethyl cellulose (EHEC), methylhydroxy butylcellulose (MHBC), carboxymethyl cellulose (CMC), carboxymethyl methylcellulose (CMMC), hydroxyethyl hydroxypropyl methyl cellulose (HEHPMC) and methyl hydroxyethyl cellulose (MHEC), and mixtures thereof, the tableting aid is selected from the group consisting of calcium stearate, magnesium stearate, stearic acid, zinc stearate, sodium stearyl fumarate, ascorbyl palmitate, micronized or non micronized talc, silica in various forms such as fumed silica, colloidal silica and precipitated silica and silica gel, sodium aluminum silicate, mineral calcium with stearic acid, glyceryl monostearate, glyceryl triacetate, hydroxypropyl methylcellulose pthalate (HPMCP), maltodextrin, octadecnonic acid, polyethylene glycol, shellac and especially purified shellac, soapstone, sodium benzoate, sodium lauryl sulfate, titanium dioxide, boric acid, sodium chloride, mineral oil and hydrogenated vegetable oil, and mixtures thereof, and the excipient is selected from the group consisting of precipitated calcium carbonate, monobasic calcium phosphate, dibasic calcium phosphate, calcium hydrogen phosphate dihydrate, calcium hydrogen phosphate dehydrate, tribasic calcium phosphate, calcium sulfate, magnesium sulfate, microcrystalline cellulose, powdered cellulose, dextrose, kaolin, lactose, sorbitol, magnesium carbonate, magnesium sulfate, mannitol, sodium chloride, starch, pregelantinized starch, sucrose, compressible sugar and confectioner's sugar, and mixtures thereof.

64. The method of claim 63, wherein the fish-attractant material comprises approximately equal amounts of L-alanine, L-arginine and L-proline; the cellulose derivative polymer is HPMC, the tableting aid is selected from the group consisting of magnesium stearate and stearic acid, and the excipient is selected from the group consisting of lactose and calcium hydrogen phosphate dihydrate.

65. The method of claim 64, wherein the fish-attractant material comprises L-alanine, L-arginine, L-proline, aspartic acid and glutamic acid in equal amounts; the cellulose derivative is HPMC having a pH of about 5.5 to about 8.0, a methoxyl content of about 19% to about 24%, an apparent viscosity in a 2% aqueous solution at 20° C. of about 78 mPa.s to about 117 mPa.s when measured by a rotation method and about 80 cP to about 120 cP when measured by a Ubbelhode method; the tableting agent is magnesium stearate; the excipient is selected from the group consisting of lactose and calcium hydrogen phosphate dihydrate; and the colorant is selected from the group consisting of red dye #40 and FD&C Aluminum Lake #40.

66. The method of claim 50, further comprising forming a bore through the fish-attractant product, such that the fish-attractant product is attachable at least one of directly and indirectly to a fishing line passing through the bore.

67. The method of claim 51, further comprising forming a bore through the fish-attractant product, by which the fish-attractant product is attachable at least one of directly and indirectly to a fishing line, wherein the bore is formed during the compressing step.

68. A method of making a fish-attractant product comprising:
(a) mixing until thoroughly blended, to form a product mixture, ingredients comprising
(i) fish-attractant material in an amount to be releasable in water for a period of time of about 15 minutes to about 60 minutes,
(ii) a hardenable release material such that the body is dissolvable in water over a period of time of about 15 minutes to about 60 minutes, and optionally
(iii) at least one colorant; and
(b) forming the fish-attractant product by treating the product mixture so that it will harden at about room temperature in a mold into a fish-attractant product having a dissolution time in water of about 15 minutes to about 60 minutes and a peak crush strength of about 25 kp to about 40 kp.

69. The method of claim 68, further comprising an intermediate step between steps (a) and (b), of providing into the product mixture an attachment member for attachment to a fishing line, whereby the attachment member is embedded within the product mixture, such that the fish-attractant product will include the attachment member as an integral part of the fish-attractant product.

70. The method of claim 69, wherein the attachment member comprises a line.
